(19) United States
(12) Patent Application Publication
(10) Pub. No.: US 2026/0022955 A1
(43) Pub. Date: Jan. 22, 2026

(54) DEVICE AND METHOD FOR DETERMINING VOLUMETRIC FLOW RATE AND QUALITY

(71) Applicant: EBM PAPST MULFINGEN GMBH & CO KG, Mulfingen (DE)

(72) Inventors: Thomas SAUER, Bad Mergentheim (DE); Sven WALTER, Bad Mergentheim-Rengershausen (DE); Daniel GEBERT, Öhringen (DE)

(21) Appl. No.: 19/267,915

(22) Filed: Jul. 14, 2025

(30) Foreign Application Priority Data
Jul. 18, 2024 (DE) 10 2024 120 359.5

(51) Int. Cl. G01F 1/28; G01F 1/075; G01F 1/684

(52) U.S. Cl. CPC G01F 1/28; G01F 1/075; G01F 1/6842; G01F 1/6847

(57) ABSTRACT

A device for determining the volumetric flow rate and quality of a gaseous fluid includes a main channel, a bypass channel, a sensor region and a primary anemometer. The main channel is configured for guiding a main flow of the fluid. The bypass channel and the sensor region form a bypass with respect to the main flow. The bypass is configured in particular parallel to the main flow. The bypass channel is configured to convey a part of the main flow as a partial flow into the sensor region. The sensor region includes at least one fluid quality sensor, at least one rotational speed sensor and evaluation electronics, and the primary anemometer is configured inside the main channel for recording the entire main flow 8 and has a functional interaction with the rotational speed sensor.

### CROSS-REFERENCE TO RELATED APPLICATION

This Application claims priority to German Application No. 10 2024 120 359.5, filed Jul. 18, 2024, the content of which is hereby incorporated by reference in its entirety.

### BRIEF DESCRIPTION OF THE DRAWINGS

FIG. 1 shows an exploded drawing of a device, in one example.

FIG. 2 shows a perspective view of a sensor box, in one example.

FIG. 3 shows a sectional drawing of an entry into a bypass channel, in one example.

FIG. 4 shows a sectional drawing of a sensor region, in one example.

### DETAILED DESCRIPTION

The present disclosure relates to the technical field of the measurement of volumetric flow rates for assessing a fluid quality in pipeline systems.

Such devices and methods are already known.

For example, document EP 3 106 671 B1 discloses a nozzle device for delivering air in a blower, comprising a nozzle housing with an outer wall face, a dust collector with at least one flow entry opening and at least one flow exit opening being provided at the outer wall face, and the at least one flow entry opening being fluidically connected via at least one housing wall opening to an interior of the nozzle device so that a part of the air delivered by the nozzle device flows as a bypass flow through the dust collector, a sensor for measuring parameters of the delivered air being arranged at the at least one flow exit opening of the dust collector in such a way that the bypass flow flowing out of the at least one flow exit opening of the dust collector impinges directly on the sensor.

It may be regarded as a technical object to improve the prior art and to develop alternatives thereto.

All features explained in connection with individual embodiments of the present disclosure may be provided in different combination in the subject matter according to the disclosure in order to produce their advantageous effect simultaneously.

The scope of protection of the present disclosure is provided by the patent claims and is not restricted by the features explained in the description or shown in the figures.

According to one aspect, the technical object of the disclosure is achieved by a device for determining the volumetric flow rate and quality of a gaseous fluid, comprising a main channel, a bypass channel, a sensor region and a primary anemometer, wherein the main channel is configured for guiding a main flow of the fluid, wherein the bypass channel and the sensor region form a bypass with respect to the main flow, wherein the bypass is configured in particular parallel to the main flow, wherein the bypass channel is configured to convey a part of the main flow as a partial flow into the sensor region, wherein the sensor region comprises at least one fluid quality sensor and at least one rotational speed sensor, wherein the sensor region comprises evaluation electronics, wherein the primary anemometer is configured inside the main channel for recording the entire main flow and has a functional interaction with the rotational speed sensor.

In other words, the bypass channel is configured in such a way as to reduce the partial flow branched off from the main flow to an extent that enables an improved fluid quality measurement.

Particularly for small volumetric flow rates, a measurement accuracy may advantageously be improved and increased. An unfavorable influence of the sensors on one another may also thereby be reduced and avoided, which can additionally advantageously have an effect on the measurement accuracy. Furthermore, fouling that could negatively influence a measurement result can be detected and the measurement accuracy can also thereby be further improved.

In one technically advantageous embodiment, it is provided that the sensor region comprises a rotational direction sensor, the primary anemometer being configured inside the main channel for recording the entire main flow and having a functional interaction with the rotational speed sensor and/or the rotational direction sensor.

In this manner, it is possible to form a measuring unit which provides further relevant measurement values and which benefits from the advantages already mentioned.

Furthermore, in a further technically advantageous embodiment, it is provided that the bypass is formed by means of a casing arranged at the main channel or by means of a casing arranged at least partially in the main channel, or by means of a sensor box, the casing or the sensor box comprising at least the bypass channel and/or the sensor region and/or the evaluation electronics and/or the at least one fluid quality sensor and/or the rotational speed sensor and/or the rotational direction sensor.

Advantageously, this may enable greater flexibility both in the production and in the installation or in the use of the device, which can have a favorable effect both on resources and costs.

Further, in one technically advantageous embodiment, it is provided that a uniform velocity of the partial flow is generated by means of guide elements, in particular by means of guide elements arranged in the sensor region, the guide elements preferably being formed by means of, or as, a wall or strut of the casing or of the sensor box.

Advantageously, a fluid velocity that is as uniform as possible in the sensor region can be generated by means of the guide elements, which can additionally improve the measurement accuracy. The guide elements may, for example, have a honeycomb structure and/or a grid structure, and/or may be configured as a honeycomb structure and/or a grid structure.

Moreover, in one technically advantageous embodiment, it is provided that at least one gas sensor and/or a particle sensor and/or a temperature sensor and/or a humidity sensor is respectively provided as fluid quality sensor, the particle sensor being arranged in particular inside the bypass channel.

Advantageously, already existing technologies may thereby economically be used and implemented. Further sensors additionally improve the measurement accuracy and may be employed in order to be able to draw better conclusions relating to the fluid quality.

Further, in one technically advantageous embodiment, it is provided that the rotational direction sensor and/or the rotational speed sensor is/are configured as a Hall sensor, the rotational direction sensor and the rotational speed sensor being configured in particular as a combined sensor formed from at least two Hall sensors.

Advantageously, the main flow and its flow direction may therefore be detected and employed for additional improvement of the measurement accuracy.

Furthermore, in one technically advantageous embodiment, it is provided that the bypass channel is configured in such a way as to generate an increase in the cross-sectional area of the partial flow by a factor of 2, in particular by a factor of 2 to 10, preferably by a factor of 2 to 20.

In this way, the fluid velocity in the sensor region may advantageously be reduced, which can additionally improve the measurement accuracy and, in particular, can be advantageous for sensors that respond sensitively to the fluid velocity.

Moreover, in one technically advantageous embodiment, it is provided that the device further comprises a secondary anemometer, in particular a hot-film anemometer, the secondary anemometer being arranged inside the partial flow, in particular inside the bypass or the bypass channel or the sensor region.

Advantageously, the measurement accuracy can thereby be additionally improved, particularly in respect of the fouling in the bypass channel.

Further, in one technically advantageous embodiment, it is provided that the primary anemometer is configured as a vane anemometer.

Advantageously, already existing technologies may thereby economically be used and implemented.

Furthermore, in one technically advantageous embodiment, it is provided that the fluid quality sensors are arranged in a shadow region of the sensor box, fluid exchange between the partial flow and the shadow region taking place either by means of diffusion or by means of air inlet openings, the air inlet openings being configured to be small in proportion to the cross section of the partial flow and being arranged in particular inside a guide element and/or an inner wall and/or a partition wall of the sensor box.

In this way, very small fluid movements can be generated in the sensor region, which can additionally advantageously have an effect on the measurement accuracy, particularly in the case of flow-sensitive sensors.

Moreover, in one technically advantageous embodiment, it is provided that the fluid quality sensors are arranged separated from one another by means of at least one inner wall, in particular a partition wall.

A possible mutual influence, in particular a thermal influence, of the sensors on one another may in this way additionally be reduced and avoided.

According to a further aspect, a technical object of the disclosure is achieved by a method for determining the volumetric flow rate and quality of a gaseous fluid by means of a device according to one of the preceding claims, comprising the following method steps:
branching off a part of the main flow of the fluid as a partial flow by means of the bypass channel to the sensor region inside the bypass and in particular reducing a velocity of the partial flow, preferably in the sensor region;
recording the fluid quality in the sensor region by means of the at least one fluid quality sensor;
recording the rotational speed and/or the rotational direction of the primary anemometer by means of the rotational speed sensor and the rotational direction sensor;
evaluating the sensor data by means of the evaluation electronics.

A method may thus also advantageously benefit from the advantages already mentioned.

In one technically advantageous embodiment, it is provided that fouling inside the bypass, in particular the bypass channel, is detected, measurement values of the primary anemometer being in particular compared with the measurement values of the secondary anemometer, a warning message being emitted in the event of a discrepancy of these measurement values, or this information being used to influence a maintenance interval, in particular a maintenance interval of the device.

This advantageously can additionally favor the use of the method and enable better operation and in particular more failsafe operation.

Exemplary embodiments of the disclosure are schematically represented in the figures and are described in more detail below.

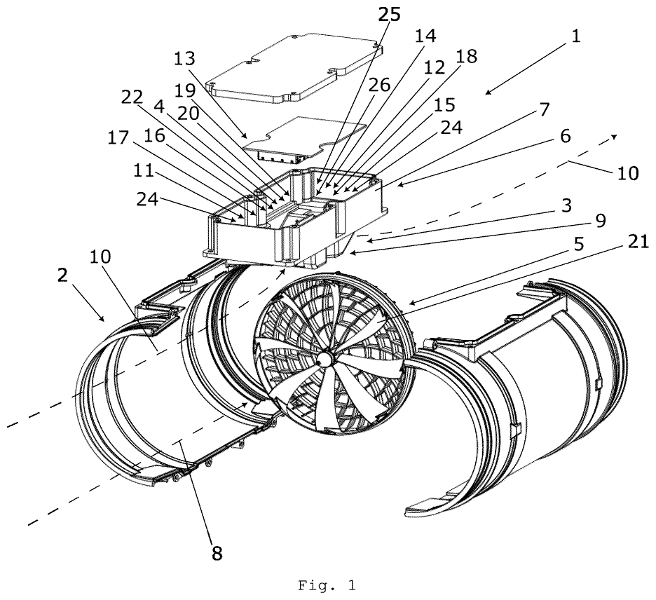

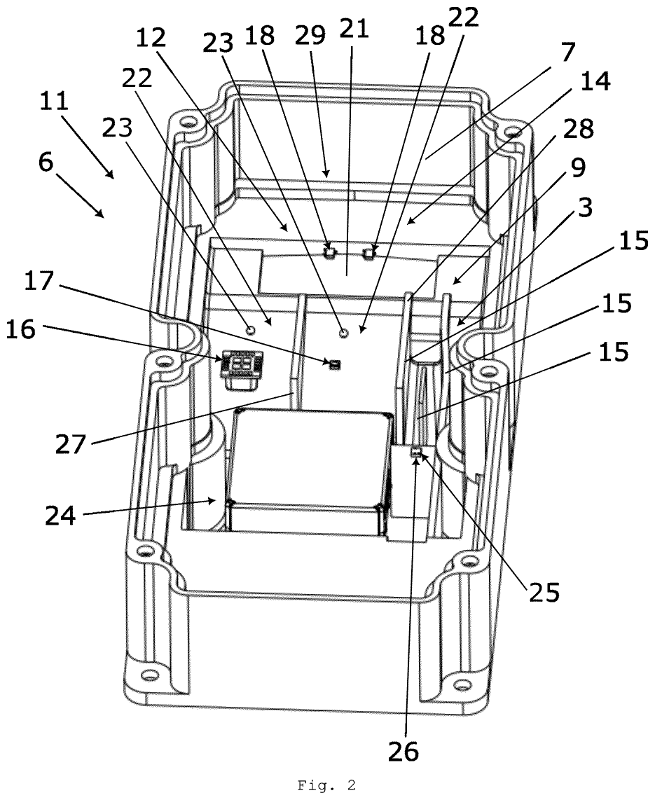

Considering FIGS. 1 to 4 together, a device 1 for determining the volumetric flow rate and quality of a gaseous fluid is represented as follows.

The device 1 comprises a main channel 2, a bypass channel 3, a sensor region 4 and a primary anemometer 5. The main channel 2 is configured for guiding a main flow of the fluid 8, the bypass channel 3 and the sensor region 4 forming a bypass 9 with respect to the main flow 8.

The bypass 9 is configured parallel to the main flow 8, the bypass channel 3 being configured to convey a part of the main flow 8 as a partial flow 10 into the sensor region 4. The sensor region 4 comprises a plurality of fluid quality sensors 11, at least one rotational speed sensor 12 and evaluation electronics 13, the primary anemometer 5 being configured inside the main channel 2 for recording the entire main flow 8 and having a functional interaction with the rotational speed sensor 12.

It is further represented that the sensor region 4 comprises a rotational direction sensor 14, the primary anemometer 5 being configured inside the main channel 2 for recording the entire main flow 8 and having a functional interaction with the rotational speed sensor 12 and/or the rotational direction sensor 14. The bypass 9 is formed by means of a casing 7, which is arranged at the main channel 2 and at least partially in the main channel 2, in the manner of a sensor box 6, the sensor box 6 comprising the bypass channel 3, the sensor region 4, the evaluation electronics 13, the fluid quality sensors 11, the rotational speed sensor 12 and the rotational direction sensor 14.

A uniform velocity of the partial flow 10 is generated by means of guide elements 15 arranged in the sensor region 4, the guide elements 15 being formed by means of, or as, a strut 17 of the sensor box 8. A first gas sensor 16, a second gas sensor 17, a particle sensor 24, a temperature sensor 25 and a humidity sensor 26 are provided as fluid quality sensors 11, the particle sensor 24 being arranged inside the bypass channel 3.

Advantageously, a very accurate conclusion relating to the fluid quality, which is associated with a very high measurement accuracy, may thus be drawn by means of a plurality of sensors in combined interaction.

The rotational direction sensor 14 and the rotational speed sensor 12 are configured as Hall sensors 18, the rotational direction sensor 14 and the rotational speed sensor 12 being configured as a combined sensor formed from two Hall sensors 18. The device furthermore comprises a secondary anemometer 19 in the form of a hot-film anemometer 20, the secondary anemometer being arranged inside the partial flow 10, inside the bypass 9 of the bypass channel 3 and the sensor region 4. It is also represented that the primary anemometer 5 is configured as a vane anemometer 21 so that, advantageously, existing technologies may economically be implemented.

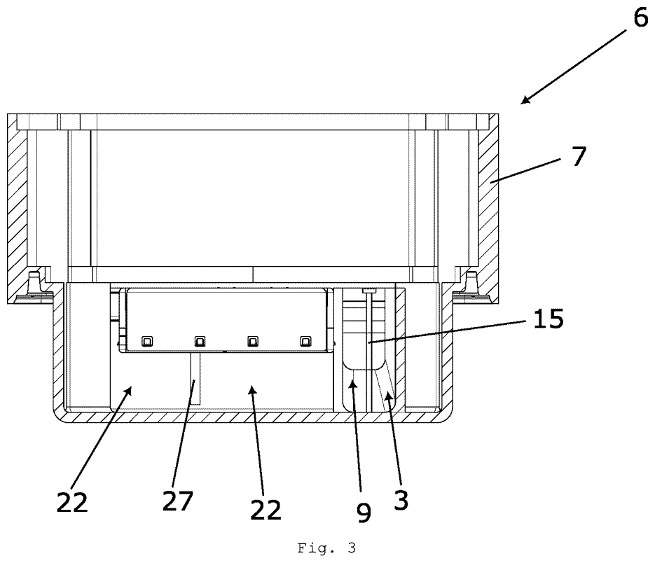

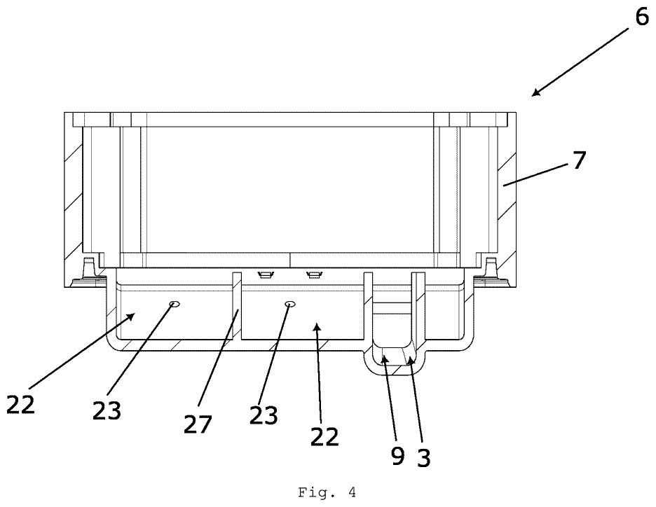

The bypass channel 3 is configured in such a way that an increase in the cross-sectional area of the partial flow by a factor of 2 to 20 can be generated, which advantageously reduces the velocity of the fluid inside the sensor box 6 and thus the sensors can operate more reliably and more accurately. This is represented particularly when considering FIGS. 3 and 4 together.

Further, considering FIGS. 1 to 4 together, it is represented that the fluid quality sensors 11 are arranged in a shadow region 22 of the sensor box 6, fluid exchange between the partial flow 10 and the shadow region 22 taking place either by means of diffusion or by means of air inlet openings 23, the air inlet openings 23 being configured to be small in proportion to the cross section of the partial flow 10 and being arranged inside an inner wall of the sensor box 6. The fluid quality sensors 11 are arranged separated from one another by means of a partition wall 27, so that a mutual influence, in particular of thermal nature, can advantageously be reduced and excluded.

Furthermore, considering FIGS. 1 to 4 together, a wall or strut of the casing 28, a combined sensor 31, an inner wall and/or partition wall of the sensor box 32 and an inner wall or partition wall 33 are represented.

Advantageously, it is therefore possible to form a measuring unit which preferably provides relevant measurement values for the quality determination, in which a mutual influence of the different sensors can be avoided. Especially when there are small volumetric flow rates, particularly in the main flow, a high measurement accuracy can be achieved and, for example, fouling that could negatively influence the measurement accuracy can be detected.

Although the present invention has been described with reference to preferred embodiments, workers skilled in the art will recognize that changes may be made in form and detail without departing from the spirit and scope of the invention.

### LIST OF REFERENCE SIGNS

1 device
2 main channel
3 bypass channel
4 sensor region
5 primary anemometer
6 sensor box
7 casing
8 main flow of the fluid
9 bypass
10 partial flow of the fluid
11 fluid quality sensor
12 rotational speed sensor
13 evaluation electronics
14 rotational direction sensor
15 guide elements
16 first gas sensor
17 second gas sensor
18 Hall sensor
19 secondary anemometer
20 hot-film anemometer
21 vane anemometer
22 shadow region
23 air inlet openings
24 particle sensor
25 temperature sensor
26 humidity sensor
27 partition wall
28 wall or strut or inner wall or partition wall of the casing or of the sensor box
29 combined sensor

1. A device for determining a volumetric flow rate and quality of a gaseous fluid, the device comprising:
a main channel,
a bypass channel,
a sensor region, and
a primary anemometer,
wherein the main channel is configured for guiding a main flow of the fluid,
wherein the bypass channel and the sensor region form a bypass with respect to the main flow,
wherein the bypass channel is configured to convey a part of the main flow as a partial flow into the sensor region,
wherein the sensor region comprises at least one fluid quality sensor, at least one rotational speed sensor and evaluation electronics, and
wherein the primary anemometer is configured inside the main channel for recording the entire main flow and has a functional interaction with the rotational speed sensor.

2. The device of claim 1, wherein
the sensor region comprises a rotational direction sensor,
wherein the primary anemometer is configured inside the main channel for recording the entire main flow and has a functional interaction with the rotational speed sensor and/or the rotational direction sensor.

3. The device of claim 1 or, wherein
the bypass is formed by means-at least one of:
a casing arranged at the main channel, or by means of a casing arranged at least partially in the main channel, or by means of a sensor box, wherein and
the casing or the sensor box comprises at least one of:
the bypass channel, the sensor region , the evaluation electronics, the at least one fluid quality sensor, the rotational speed sensor, or the rotational direction sensor.

4. The device of claim 1, wherein a uniform velocity of the partial flow is generated by means of guide elements.

5. The device of claim 1, wherein at least one gas sensor and/or a particle sensor and/or a temperature sensor and/or a humidity sensor are respectively provided as fluid quality sensors.

6. The device of claim 2, wherein the rotational direction sensor and/or the rotational speed sensor is/are configured as a Hall sensor.

7. The device of claim 1, wherein the bypass channel is configured in such a way as to generate an increase in the cross-sectional area of the partial flow by a factor of 2.

8. The device of claim 1, and further comprising a secondary anemometer arranged inside the partial flow.

9. The device of claim 1, wherein the primary anemometer is configured as a vane anemometer.

10. The device of claim 5, wherein
the fluid quality sensors are arranged in a shadow region of a sensor box,
fluid exchange between the partial flow and the shadow region takes place either by means of diffusion or by means of air inlet openings, and
the air inlet openings are configured to be small in proportion to the cross section of the partial flow.

11. The device of claim 1, wherein the fluid quality sensors are arranged separated from one another by means of at least one inner wall.

12. A method for determining a volumetric flow rate and quality of a gaseous fluid, the method comprising:
branching off a part of a main flow of the gaseous fluid as a partial flow by means of a bypass channel to a sensor region inside a bypass
recording a fluid quality in the sensor region by means of the at least one fluid quality sensor;
recording a rotational speed and/or a rotational direction of a primary anemometer by a rotational speed sensor and a rotational direction sensor; and
evaluating the sensor data by evaluation electronics.

13. The method of claim 12, wherein
fouling inside the bypass is detected, and
a warning message is emitted in the event of a discrepancy of these measurement values, or is used to influence a maintenance interval.

14. The device of claim 1, wherein the bypass is configured parallel to the main flow.

15. The device of claim 4, wherein the guide elements are arranged in the sensor region.

16. The device of claim 15, wherein the guide elements are formed by means of, or as, a wall or strut of the casing or of a sensor box.

17. The device of claim 5, wherein the particle sensor is arranged inside the bypass channel.

18. The device of claim 6, wherein the rotational direction sensor and the rotational speed sensor are configured as a combined sensor formed from at least two Hall sensors.

19. The device of claim 8, wherein the secondary anemometer comprises a hot-film anemometer arranged inside the bypass or the bypass channel or the sensor region.

20. The device of claim 10, wherein the air inlet openings are arranged inside a guide element and/or an inner wall and/or a partition wall of the sensor box.
